(19) United States
(12) Patent Application Publication
(10) Pub. No.: US 2007/0057484 A1
(43) Pub. Date: Mar. 15, 2007

(54) In-folding motorcycle foot rests

(76) Inventor: Greg Gilman, Antioch, CA (US)

Correspondence Address: QUINE INTELLECTUAL PROPERTY LAW GROUP, P.C., P O BOX 458, ALAMEDA, CA, 94501, US

(21) Appl. No.: 11/488,922

(22) Filed: Jul. 17, 2006

Related U.S. Application Data
(60) Provisional application No. 60/700,463, filed on Jul. 18, 2005.

(51) Int. Cl. B62J 25/00

(52) U.S. Cl. 280/291

(57) ABSTRACT

This invention provides foot rests for motorcycle riders. The foot rests can be stowed in close to the motorcycle frame by folding at pivotable mounts. The foot rests can be quickly deployed when needed for the rider's safety and comfort.

### CROSS-REFERENCE TO RELATED APPLICATIONS

This application claims priority to and benefit of a prior U.S. Provisional Application No. 60/700,463, In-Folding Motorcycle Foot Rests, by Greg Gilman, filed Jul. 18, 2005. The full disclosure of the prior application is incorporated herein by reference.

### FIELD OF THE INVENTION

Motorcycle highway foot rests. In particular, compact foot rests that can fold away at one or more articulations when not deployed. The present invention includes articulated foot rests that can deploy on actuation of a latch mechanism, e.g., by a motorcycle rider's boot.

### BACKGROUND OF THE INVENTION

In routine driving of a typical motorcycle, the operator sits up straight with his hands on the handle bars and his feet on foot pegs directly below the rider's seat. The operator typically controls a rear brake from the pegs with one foot and a gear shifter with the other foot. However, on long trips down the highway, remaining in this position can become somewhat uncomfortable. This, even though with the motorcycle configured for cruising on an open road, instances requiring braking and gear shifting can become rare. On those long rides, a motorcyclist would like to have optional riding positions to minimize fatigue.

A reclined riding position can be an especially desirable option on long trips. Highway pegs, such as those described in U.S. Pat. No. 3,794,343, Foot Rest for Road Vehicle, to Oliver, can afford raised and forward support of the feet and legs so the rider can recline. Resting the feet on the highway pegs can help blood circulation in the legs and change the pressure points in the seat so that the rider can go further with more comfort between stops. However, many highway pegs are bulky, heavy, not far enough forward, and do not compliment the appearance of the motorcycle.

Highway pegs have been mounted onto crash bars. For example, in U.S. patent application 2005/0116443, Motorcycle Engine Guard and Foot Peg, by Egan, flip-up highway pegs are mounted to a crash bar frame for added comfort and safety. However, even with the pegs retracted, the crash bar can remain bulky and cumbersome, if not unsightly.

In view of the above, a need exists for a forward motorcycle foot rests that stay out of the way when not in use. It would be desirable to have unobtrusive forward foot rests that are easily deployable when they are needed. Benefits could also be realized through light weight forward foot rests that provide level of protection to the engine and gas tank during spills. The present invention provides these and other features that will be apparent upon review of the following.

### SUMMARY OF THE INVENTION

The foot rests of the present invention provide safety and comfort to the rider of a motorcycle, yet can be folded away inconspicuously when not in use. The foot rests can include inner arms mounted to the motorcycle frame and outer arms that can pivot from the end of the inner arm. Either or both of the arms can act as foot rests.

The motorcycle foot rests can include, e.g., a mounting bracket, an inner arm pivotably mounted to the bracket, and an outer arm pivotably mounted to the outer section of the inner arm. In some cases, the inner arm can be mounted solidly to the frame, without a pivotable mount, while the outer pivotable mount between the inner and outer arms has a pivot axis that is substantially vertical, or at least within about 60 degrees of vertical. Optionally, the foot rests can include a mechanism for automatic release and deployment of the outer arm, e.g., while the motorcycle is being driven.

The mounting bracket can be mounted to the motorcycle frame in any way suitable for a particular motorcycle. The mounting bracket can be mounted on the motorcycle frame so that the inner arm and/or outer arm of the foot rest can functionally receive the a foot of the motorcycle driver or a passenger. The mounting bracket can be slidably mounted (e.g., with a clamp on a tubular frame member) allowing vertical repositioning of the foot rest on the frame or allowing horizontal repositioning of the footrest. Inner arms can be directed forward of the motorcycle transverse axis, to offset the outer arm forward, e.g., for long legged riders or short frames. Foot rests on either side of the motorcycle can share the same mounting bracket or each can have its own mounting bracket.

The mounting bracket and inner arm can interact to provide an inner pivotable mount. In most cases, the inner mount allows the inner arm to be moved between substantially horizontal deployed positions and substantially vertical stowed positions, e.g., along a frame member. Stowed positions are typically with the inner arm held out of the way, e.g., near a frame member. Inner pivotable mounts can pivot on a substantially horizontal axis, e.g., with the inner arm moving in an arch within a substantially vertical plane. The inner pivotable mount can have a position locking mechanism capable of holding the inner arm in the deployed and/or stowed positions. For example, the inner arm can be locked in an orientation directed up, directed down, and/or directed horizontally. In a preferred embodiment, the inner pivotable mount is a peg-in-slot joint.

The outer arm can be attached to the inner arm at an outer pivotable mount, e.g., so that the outer arm can be folded in on the inner arm or extended out in functional relation with a rider's foot. With the inner arms deployed in a substantially horizontal position, the outer arms can pivot on an axis within about 45° of vertical, or on a substantially vertical axis. In preferred embodiments, the outer arm pivots on an axis oriented substantially 90 degrees from a pivot axis of the inner arm.

The outer arm and/or inner arm can have a longitudinal slot capable if receiving all or part of the other arm. For example, the inner arm can have a longitudinal slot running from the outer pivotable mount in toward the mounting bracket. The outer arm can pivot in to nest substantially within the inner arm in the slot in the fashion of a foldable knife. And, like a foldable knife, the pivotable mount can have detents or locks that allow the arms to be held at one or more desired positions. For example, the outer pivotable mount can have a stop mechanism that does not allow the outer arm to extend substantially beyond 180° relative to the inner arm. In many preferred embodiments, the outer pivotable mount has a stop providing an angle presenting the outer arm in an orientation substantially perpendicular to a rider's lower leg when her foot is resting on the outer arm during operation of the motorcycle.

The in-folding foot rests can have various combinations of mounting forward angles, inner mount angles, outer mount angles, and arm lengths, etc., appropriate to provide the desired extension and rest positions on particular motorcycles. In certain embodiments, the inner arm is horizontal and orientated at about 60° to 45° forward from a longitudinal axis of the motorcycle and the outer arm is oriented at about 90° from the longitudinal axis (e.g., outer angle about 135° to about 120° directed opposite the inner arm angle), when the foot rest is deployed. This configuration can extend the foot rest location on the outer arm forward while avoiding interference with the turning of the motorcycle front wheel.

In one aspect of the invention, the deployment of the outer arm is automatic, e.g., like a switch-blade knife. For example, the inner arm can have a longitudinal slot to receive the outer arm, as described above. A latch mechanism, such as a spring loaded button with a part protruding into the slot can capture a groove in the inner arm, thus releasably locking the inner arm and outer arm in a closed (e.g., with an outer angle less than about 15° to substantially a 0° angle) position. The outer mount can be spring loaded with tension urging the outer arm to pivot away from the inner arm. When the external part of the button is pressed, e.g., with the rider's boot heel, the outer arm can automatically flip out to the deployed position and the rider can rest his feet on the outer arm to enjoy an extended and elevated leg position.

The foot rests of the invention can have additional features to increase their utility as comfort devices. The foot rests can have frictional surfaces or irregular surfaces on the inner arm or outer arm to prevent slipping of the rider's foot from resting positions. The foot rests can be very strong, e.g., fabricated with a metal or a composite material, such as tool steel, stainless steel, carbon fiber composites, titanium, and the like. The foot rests can be designed with materials and structure, as known in the art, to withstand a force of 200 pounds, 400 pounds, 1000 pounds, or more, without breaking or bending more than 5%. For example, the when such forces are applied in a forward direction on the end of a mounted and deployed foot rest outer arm having a total length (inner arm plus outer arm) of 15 inches, the outer arm will not deflect more than ¾ of an inch. In preferred embodiments, the foot rest does not deflect more than ¼ inch.

### Definitions

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular devices or mechanical systems, which can, of course, vary. It is also to be understood that the terminology used herein is for the purpose of describing particular embodiments only, and is not intended to be limiting. As used in this specification and the appended claims, the singular forms “a”, “an” and “the” can include plural referents unless the content clearly dictates otherwise. Thus, for example, reference to “frame member” can include a combination of two or more members; reference to “a metal” can include mixtures of metals, and the like.

Although many methods and materials similar, modified, or equivalent to those described herein can be used in the practice of the present invention without undue experimentation, the preferred structures, materials and methods are described herein. In describing and claiming the present invention, the following terminology will be used in accordance with the definitions set out below.

As used herein, the term “pivotably mounted” refers to mounting of a first component (e.g., a mount or arm) to a second component so that so that the first component can pivot relative to the second component. For example, a door can be pivotably mounted to a door frame and pivot on the door hinge relative to the door frame. A “pivot axis” refers to a line running through a point at which a component pivots and perpendicular to the plane of an arc described by the pivoting motion of the component. For example, doors typically pivot on a vertical “pivot axis” described, e.g., by the longitudinal axis of the hinge pin.

A “longitudinal axis” of an upright motorcycle refers to a horizontal axis running in a plane that symmetrically bisects the motorcycle from the front of the motorcycle to the back of the motorcycle. A “transverse axis” of a motorcycle refers to an axis running horizontal and perpendicular to a longitudinal axis.

As used herein, the term “deployed” refers to a configuration of the foot rest for use as a foot rest. For example, the inner arm can be deployed when it is in a substantially horizontal position; the outer arm can be deployed when it is extended from the inner arm. The term “stowed”, as used herein, refers to a configuration of the foot rest components in a closed or in-folded position. For example, the inner arm can be considered stowed when it is in a vertical position or pivoted in a position out of the way adjacent to the motorcycle frame; the outer arm can be considered stowed when it is folded back retracted along the inner arm, e.g., with an outer angle near 0 degrees.

### BRIEF DESCRIPTION OF THE DRAWINGS

FIG. 1 is a schematic diagram of a foot rest mounted to a motorcycle.

FIG. 2 is a schematic diagram of a mounting bracket and inner arm providing a pin-in-slot position locking mechanism.

FIG. 3 is a schematic diagram looking down on a motorcycle having mounted foot rests of the invention.

FIG. 4 is a schematic diagram of a foot rest having a clamp style mount and an automatic outer arm deployment feature.

FIG. 5 is a schematic diagram of an exemplary foot rest showing an inner pivotable mount with an angled slot orientation, and a spring loaded outer arm deployment mechanism having an externally actuatable release latch.

### DETAILED DESCRIPTION

In-folding motorcycle foot rests can be folded into a stowed configuration, e.g., in close to a frame member to which they are mounted or retracted near some other structure of the motorcycle. The foot rests can be readily deployed in stages to provide convenience, style and comfort. The in-folding foot rests can each include, e.g., a mounting bracket, an inner arm that pivots from vertical to horizontal positions from the mounting bracket, and an outer arm that pivots in a horizontal plane from the outer end of the inner arm. In the stowed position, e.g., the outer arm can be folded into the inner arm and the inner arm can pivoted up to rest retracted against the motorcycle frame. The inner arm can be deployed and locked extended in a horizontal position, e.g., to act as an inner forward foot rest. The outer arm can be deployed, e.g., by pressing a release button, to provide an outer forward foot rest.

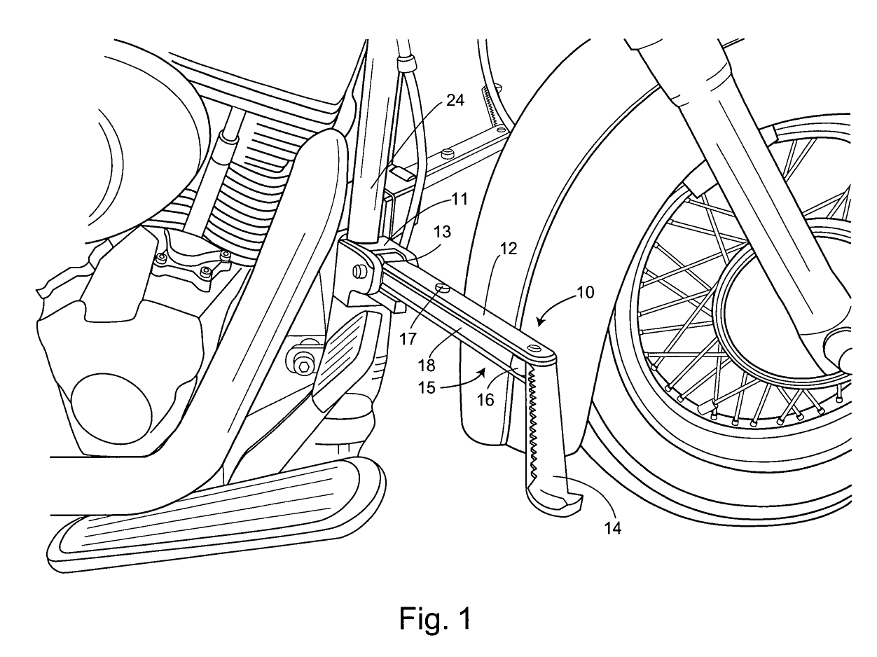

In one embodiment, the foot rests 10 of the invention include a mounting bracket 11 mounted to a motorcycle tubular front frame member 24 with a clamp (see FIG. 1). The inner arm 12 is attached to the mounting bracket 11 with a pivotable mount 13 (comprising interacting elements of the bracket and inner arm) that allows motion between a vertical stowed position and a horizontal deployed position. A clip on the frame can help hold the inner arm in the stowed position and the inner pivotable mount can be lockable in the deployed horizontal position. The outer arm 14 can pivot in a horizontal plane from the outer section 15 (e.g., outer end) of the deployed inner arm to extend out in a fashion similar to opening a jack-knife. The outer pivotable mount 16 (comprising interacting elements of the inner and outer arms) between the inner arm and outer arm can have a detent mechanism to retain the outer arm in the deployed position. In use, the deployed foot rests can provide the option for the rider to rest his foot on the outer arm or the inner arm. The deployed foot rests can possibly protect some motorcycle components should the bike tip over. The foot rests of the invention do not require additional structural members, such as, e.g., struts and diagonal braces, to function (although one can envision means to provide such additional structure).

In some embodiments, the outer arm can be automatically deployed from the inner arm by the rider pressing a release button 17, e.g., with his boot heel. For example, the outer pivotable mount can include spring loading urging the outer arm to pivot away from the inner arm. The inner arm can be held in the stowed position, e.g., in an inner arm longitudinal slot 18, by a latch mechanism with an external release button. Pressing the button can allow the spring to force the outer arm to pivot and extend into the deployed position. In alternate embodiments, the outer arm can have a slot to receive the inner arm as the outer arm is retracted and stowed.

The folding foot rests can be fabricated from any appropriate materials, such as, e.g., metals or composites. For example they can be made from stainless steel, tool steel, aluminum, carbon fiber composites, titanium, and/or the like. The separate components can be manufactured, e.g., by casting, forging, welding, tube bending, machining, curing, and/or the like. In preferred embodiments, the foot rest components are fabricated by machining of billet stock materials. It has been found that foot rests described herein have adequate strength to provide foot rest functions without requiring further structural members.

Mounting Brackets

Mounting brackets are used to mount the foot rests to a motorcycle frame. Inner arms are attached to the mounting brackets with an appropriate inner mount, typically a pivotable and/or lockable mount.

Numerous mounting techniques can be used to attach mounting brackets to motorcycle frames. For example, the brackets can be clamped, welded, brazed, bolted, riveted, screwed, and/or the like, to the frame. In certain preferred embodiments, the bracket is attached by clamping. Foot rests attached to a motorcycle by clamping can have the advantages of, e.g., easy removal, an ability to reposition the mounting height by loosening the clamp and sliding the mounting bracket up or down a frame tube, an ability to reposition the mounting angle forward or back by loosening the clamp and pivoting about the frame tube, and adjustment of the give point in the mount according to the tightness of the clamp. When the frame does not have tubular frame members available for mounting, e.g., in the passenger area of many motorcycles, it can be preferred to mount the foot rests to the frame by welding, bolting, or screwing into threaded mounting locations in the frame. In many cases, stock passenger pegs can be replaced by folding foot rests of the invention having compatible mounting brackets, e.g., with the same standard mounting bolt threads as the stock pegs.

Mounting brackets can be designed, as appropriate, for mounting on various types of motorcycles and to suit various safety and comfort needs. Many motorcycle frames have a pair of near vertical, or slightly forward leaning, front tubes in front of the engine. In such a case, a single foot rest can be mounted to each tube. Optionally, a single mount, e.g., running across and clamped to both tubes, can be shared by a pair of left and right foot rests.

In certain embodiments, e.g., where motorcycle components, such as oil coolers, skid plates, cowlings, etc, block access to the frame or otherwise interfere with placement of the mounting bracket, the bracket can include an extension (e.g., an elongated segment between the mount/frame interaction and the inner pivotable mount) to the bracket to extend and/or offset the location of the inner mount interaction with the inner arm. Mounting bracket extensions are typically not pivotable and are integral structures of the mount. For example, where the mounting bracket is mounted to a frame location higher than desired for the height of the deployed inner arm, the mount bracket can include a solid offset extension that extends out and down from the frame mounting location to establish a lower position for the inner mount to the inner arm.

In some embodiments of the foot rests, the mount can optionally include a break-off feature. For example, the mount can release from the frame, break internally or break at the inner mount, when subjected to certain levels of force. The benefit of the break-off feature can be that excessive force is not delivered to the motorcycle frame during a collision, thus avoiding bending or breaking of the frame. The break-off feature can allow the rider to retain control of the motorcycle when the foot rest strikes a solid object. One skilled in the art can envision various ways to provide the break-off feature. For example, the mounting bracket can be clamp mounted to the frame using shear pins of desired strength, the mount body can include an extension that will break at a desired level of force, the mount pin at the inner pivot can have materials and/or dimensions breakable at a desired level of force, the mount bracket can include perforations or cuts weakening the mount in a desired direction and susceptible to a desired level of force, etc.

A foot rest catch can be provided spaced along the frame from the mounting bracket, e.g., for grasping a stowed foot rest to help retain the stowed position and minimize abrasion or vibration of the foot rest against the frame. Such a catch can be any appropriate type known in the art, such as, e.g., a resilient clip, VELCRO belt, spring loaded ball catchment, a magnet, and the like.

Inner Arms

Inner arms can be deployed to function as inner forward foot rests. In addition, inner arms can, e.g., receive infolded outer arms and provide the mounting locations for outer arms.

Inner arms can be solidly attached to the mounting bracket, e.g., by welding or by casting as one piece with the mounting bracket. More typically, the inner arm and mounting bracket are separate pieces that interact at a pivotable mount that allows the inner arm to pivot between stowing positions (e.g., up or down along the frame) and a deployed position (e.g., horizontal and somewhat forward). For example, in preferred embodiments, the deployed inner arm can be horizontal (e.g., while the motorcycle is being ridden straight on a horizontal surface), within about 10 degrees of horizontal, within about 30 degrees of horizontal, or within about 45 degrees from horizontal or more. The inner arm can be extended laterally and/or forward at an angle suitable to avoid conflict with turning of the front wheel and/or to extend the outer arm forward (e.g., for taller riders).

Inner arms can have a length from less than about 3 inches to more than about 12 inches, or from about 5 inches to about 10 inches, or about 7 inches. The inner arms can be less than about 0.5 inches thick to more than about 3 inches thick, from about 0.7 inches to about 2 inches thick, or about 0.75 inches thick, depending, e.g., on the materials and desired strength. The inner arms, can tolerate the stress of 200 foot-pounds, 500 foot-pounds, 1000 foot pounds, or more, without breaking, taking on a significant permanent deflection (bend) from the original shape, and/or deflecting more than 5% relative to length; thus providing functional capabilities of a motorcycle foot rest. This can be accomplished using the materials and dimensions described herein.

The inner arm can pivot from the mounting bracket and be lockable at one or more positions in the range of motion. For example, the inner arm can have a pivot pin (or swing on a pivot pin of a mounting bracket), as is known in the art, to swing up and down from a vertical stowed position to a horizontal deployed position. The inner arm can be stopped vertically by contact with the frame and locked in place by a catch, as described above. Alternately, the inner arm can be locked in a stowed vertical position by a detent, magnet, pin-in-slot mechanism, bolt and wing nut, or the like. The inner arm can be locked horizontally deployed by a position locking mechanism, such as a stop located in the pivoting path of the arm. For example, an extension of the mounting bracket can project out horizontally to interfere with progress of the inner arm below the horizontal position.

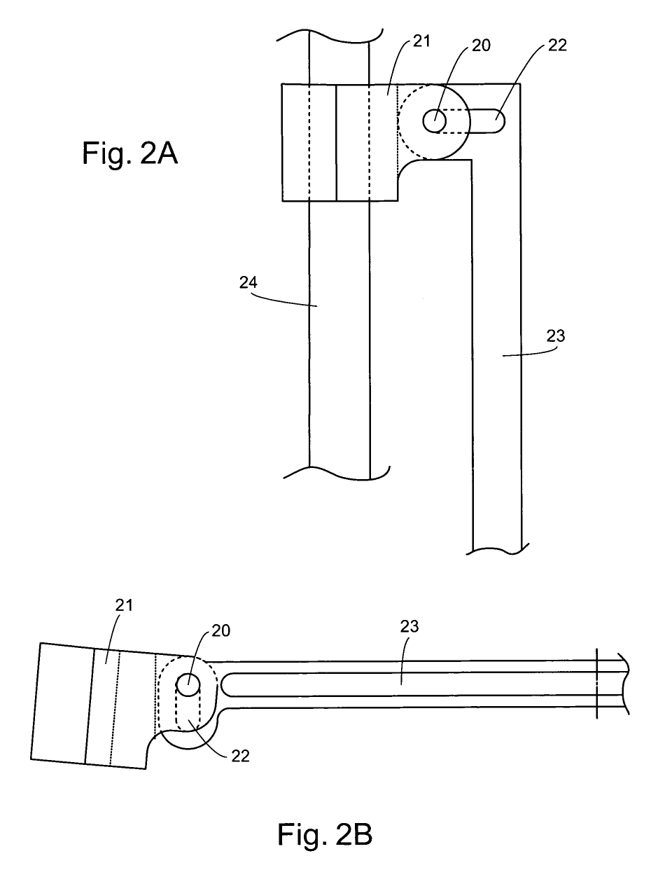

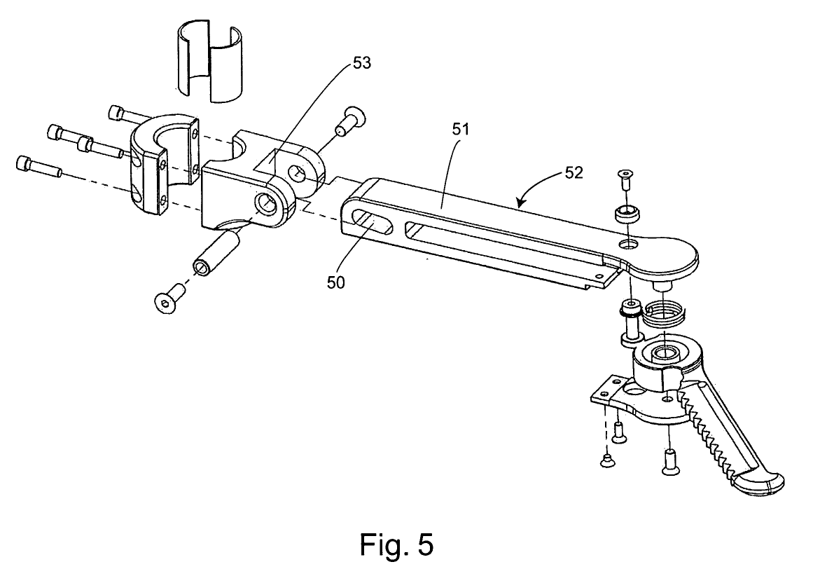

Optionally, as shown in FIG. 2, the inner arm can be locked in the deployed position with a pin in slot mechanism. For example, pin 20 fixed in mounting bracket 21 passes through slot 22 of inner arm 23. In the stowed position, shown in FIG. 2A, the inner arm can hang freely from the mounting bracket on frame member 24. In the locked deployed position, shown in FIG. 2B, the inner arm has been raised up and the pin slid to the other end of the slot so that the inner arm binds in the mounting bracket, thus locking it in a horizontal position. The slot can be oriented at such an angle that the inner arm wedges into the mount to further stabilize the arm in deployed and/or stowed positions. In a preferred embodiment, the axis of inner arm slot is not parallel to the contact surface between the mounting bracket and the inner arm or not parallel to the axis of the inner arm. For example, the slot 50 shown in FIG. 5 can be oriented at a small angle relative to the upper surface 51 of the inner arm 52 so that the arm tends to stably wedge against mounting bracket contact surface in the deployed position and/or the stowed position. This configuration of the pin-in-slot pivotable mount can help secure the arm in the desired position, eliminate unwanted clearances in the mount mechanism and prevent rattling of the arm from engine and road vibrations.

Outer Arms

Outer arms can act as foot rests in the deployed position. Outer arms can be folded back along inner arms in the stowed position.

Outer arms are attached to inner arms. Outer arms can be attached at the outer ends or outer sections of inner arms. The outer section of an inner arm can be considered to include the outer (most lateral at deployment) end of the inner arm, and the outer 50% of the inner arm, the at least outer 25% of the inner arm, or at least the outer 10% of the inner arm. The attachment can be a pivotable mount, such as a pinned hinge. In embodiments wherein the attachment is a pivotable mount, and the pivot point is located a significant percent in from the outer end of the inner arm, the outer end of the inner arm can conflict with the pivoting outer arm to establish a full open limit to the pivot. Alternately, the pivotable mount can be configured with the pivot point located at a point along the inner section of the outer arm and the pivot can be limited by a conflict of the inner arm with the inner end of the outer arm to limit the range of joint motion, in the manner of a human elbow.

In preferred embodiments, the outer arm is pivotable on the inner arm with a pivot axis approximately perpendicular to the pivot axis of the inner arm pivot on the mounting bracket. In a preferred embodiment the outer arm is pivotable through an arch in a plane perpendicular to the plane of inner arm motion. In a preferred embodiment, the outer arm pivots on a substantially vertical axis, an axis within about 30 degrees of vertical, within about 45 degrees of vertical, or within about 60 degrees of vertical, when the outer arm is moved between deployed and stowed positions on the deployed inner arm. In a preferred embodiment, the outer arm pivoting motion during deployment or stowing describes an arch in a substantially horizontal plane while the inner arm is in the deployed position.

Outer arms can have a length from less than about 4 inches to more than about 15 inches, or from about 6 inches to about 12 inches, or about 8 inches. The outer arms can have a length about the same as the inner arms. In some embodiments the inner arm shorter; in preferred embodiments, the outer arm is slightly longer than the inner arm. The outer arms can be less than about 0.5 inches thick to more than about 3 inches thick, from about 0.7 inches to about 2 inches thick, or about 0.75 inches thick, depending, e.g., on the materials and desired strength. The outer arms, can tolerate the stress of 200 foot-pounds, 500 foot-pounds, 1000 foot pounds, or more, without breaking, taking on a significant permanent deflection (bend) from the original shape, and/or deflecting more than 5% relative to length. In preferred embodiments, the outer arms would not deflect more than 2% relative to their length.

In the stowed position, the outer arm can rest along side the inner arm. Optionally the outer arm can be stowed fully or partially in a longitudinal slot of the inner arm, and/or with the inner arm fully or partly in a longitudinal slot of the outer arm. For example, in a preferred embodiment, the outer arm can fold into a slot of the inner arm in a manner similar to the closing of a jack knife blade into the knife handle.

The pivotable mount of the outer arm at the inner arm (outer pivotable mount), can include a lock or detent mechanism to hold the outer arm in a stowed and/or deployed position. For example, when the outer arm reaches its fully deployed extent, a spring loaded dog can fall from an edge (escapement mechanism) in the inner part of the outer arm, to prevent closure of the joint. The dog can be associated with a lever or button that removes the dog from the edge when pressed so the outer arm can be stowed. Optionally, the outer arm can be retained in the deployed position by friction, spring loading or the rider's foot, with the outer arm held at the furthest deployed extension by a stop that interferes with further extension of the outer arm. Such a stop can be established to prevent pivoting of the outer arm to an outer angle more than about 180 degrees, 150 degrees, 135 degrees, 120 degrees, or 90 degrees. Optionally then typically obtuse angle measured between the inner and outer arms (i.e., the “outer angle” of the outer pivotable mount) can be fixable at two or more different angles. For example, a clamping or frictional device at the pivotable mount can freeze the outer arm at a desired angle. In another example, a spring loaded pin mounted in the inner arm can be alternately inserted in any one of a series of holes in the inner end of the outer arm to hold the outer pivotable mount at a choice of desired angles.

The outer pivotable mount can be lockable to endure large forces associated with a motorcycle tipping or sliding sideways on a roadway. This can be accomplished with appropriately designed locking mechanisms, as described above and known in the art. Optionally, the outer pivotable mount can release (e.g., by inclusion of a break away structure) when struck along the forward edge (as viewed deployed on a motorcycle). For example, it can be desirable to allow the outer arm to pivot back to minimize harm to objects that are struck and/or to help retain control in a collision with an unyielding object. In preferred embodiments, the inner arm can be less yielding than the outer arm so that the rider's foot can be pushed to the protection of the inner arm should the outer arm strike an immovable object.

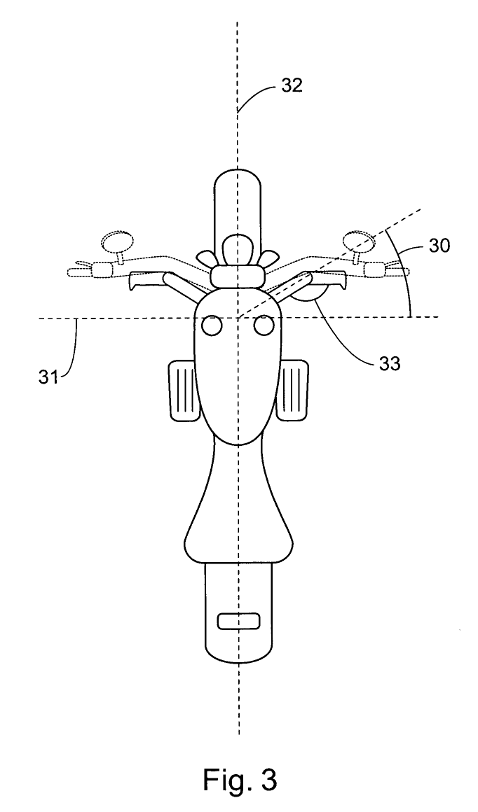

In preferred embodiments, the deployed angle between the outer arm and inner arm is such that the outer arm is substantially perpendicular to the lower leg of a rider when in use. For example, as shown in FIG. 3, if the inner arm is extended forward at an inner angle 30 of 30 degrees from a line perpendicular (transverse axis 31) to the longitudinal axis 32 of the motorcycle, the outer angle 33 at the outer pivotable mount can be about 150 degrees (or from about 120 degrees to 150 degrees, or about 145 degrees) so the outer arm presents a functional foot rest approximately parallel to the plane of the riders boot sole or approximately perpendicular to the riders lower leg during reclined operation of the motorcycle.

The outer arm can be automatically deployed, e.g., as described above. A spring in the outer pivotable mount can urge the outer arm away from the inner arm. A latch mechanism can be built into the inner arm or outer arm to hold the outer arm in a stowed position until, e.g., a button on the latch is pressed to release the outer arm for automatic deployment.

The outer arm can have a surface providing traction and comfort for the rider's foot. The surface of the deployed outer arm can have an irregular contour so that the rider's foot does not slip under the forces of riding. The outer arm can be provided with a resilient (e.g., rubberized) surface to reduce transmission of vibration and to provide friction. The outer end of the outer arm can have a hook, stop, or other protrusion, to prevent lateral slippage of the rider's foot from the foot rest.

### EXAMPLE

### The Highway Blade

The following examples are offered to illustrate, but not to limit the claimed invention.

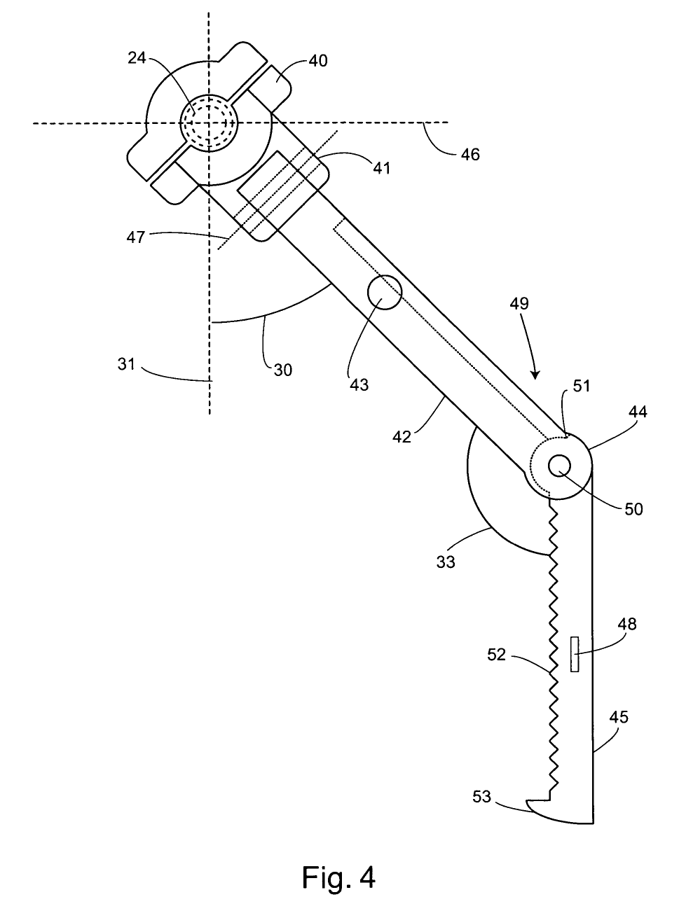

In-folding motorcycle foot rests were fabricated from tool steel to include a clamp type mounting bracket 40, an inner pivotable mount 41 having a pin-in-slot mechanism, an inner arm 42 featuring a push button release 43, an outer pivotable mount 44 for attachment of outer arm 45, as seen from above deployed in FIG. 4.

The mounting bracket can be clamped onto tubular front frame members at any inner angle 30 relative to a line 31 parallel to the longitudinal axis 46 of a motorcycle. This angle can be adjusted (repositioned) by simply loosening the clamp and pivoting the mounting bracket about the axis of the frame tube 24. The height of the entire foot rest can be adjusted (repositioned) by simply loosening the bracket clamp and sliding the bracket up or down the frame tube.

The inner arm 42 is mounted to the mounting bracket using a pin-in-slot mechanism, as shown in FIG. 2. The inner arm can pivot on axis 47 between stowed (vertical) and deployed (horizontal) positions. The release button is positioned over a longitudinal slot in the inner arm that can receive the outer arm. The release mechanism 43 extends into the slot with a spring loaded latch that functionally engages a groove 48 in the outer arm to hold the outer arm in a stowed position (e.g., with a outer pivotable mount angle of about 0 degrees).

The outer section 49 of the inner arm interacts at the outer end with the inner end of the outer arm to form the outer pivotable mount 44. The outer mount includes pin 50 with a substantially vertical pivoting axis. The outer arm (about 8 inches long) can pivot to extend out to the deployed position until stop 51 prevents further extension establishing outer angle 33 presenting the outer arm substantially perpendicular to the longitudinal axis.

The outer arm has an irregular surface 52 and an outer protrusion 53 to help prevent a riders foot from slipping off the foot rest.

When not in use, the outer arm can be stowed by folding it into the inner arm. The latch can capture the outer arm groove 48 to hold the outer arm in the stowed position against the force of the spring (not shown). In this condition, the inner arm can remain deployed to act as an inner foot rest and bumper to protect the engine and gas tank against contact with the road should the motorcycle fall over. Optionally, the inner arm can be stowed by lifting up on its inner end to slide the pin to a position of the pin-in-slot mechanism allowing the arm to pivot down vertically.

With the foot rest mounted to a HARLEY-DAVIDSON SOFTAIL, a rider pushing on the fully deployed outer arm with a force of more than 200 pounds did not deflect the outer end of the outer arm more than ¼ inch.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, many of the techniques and apparatus described above can be used in various combinations.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A foot rest for mounting onto a frame of a motorcycle, the foot rest comprising:
a mounting bracket;
an inner arm pivotably mounted to the bracket and comprising an outer section; and,
an outer arm pivotably mounted to the inner arm outer section.

2. The foot rest of claim 1, wherein the mounting bracket is mounted on the motorcycle frame to functionally receive a foot of a driver or passenger at the inner arm or at the outer arm.

3. The foot rest of claim 1, wherein the mounting bracket is slidably mounted allowing vertical repositioning of the foot rest on the frame or allowing horizontal repositioning of the footrest.

4. The foot rest of claim 1, wherein the foot rest is mounted to the motorcycle with the inner arm directed forward of a transverse axis of the motorcycle, thus forward offsetting the outer arm.

5. The foot rest of claim 1, wherein the foot rest shares the mounting bracket with another foot rest or each foot rest has separate unshared mounting brackets.

6. The foot rest of claim 1, wherein the inner pivotable mount comprises a position locking mechanism.

7. The foot rest of claim 6, wherein the locking mechanism is configured to lock the inner arm in an orientation selected from the group consisting of: directed up, directed down, and directed horizontally.

8. The foot rest of claim 1, wherein the inner pivotable mount comprises a pin-in-slot joint.

9. The foot rest of claim 1, wherein the inner pivotable mount pivots on a substantially horizontal axis.

10. The foot rest of claim 1, wherein the outer arm pivots on an axis oriented substantially 90 degrees from a pivot axis of the inner arm.

11. The foot rest of claim 1, wherein, with the inner arm in a horizontal position, the outer arm pivots on an axis within 45° of vertical.

12. The foot rest of claim 1, wherein, with the inner arm in a horizontal position, the outer arm pivots on a substantially vertical axis.

13. The foot rest of claim 1, wherein the inner arm further comprises a longitudinal slot capable of receiving all or part of the outer arm or the outer arm comprises a longitudinal slot capable of receiving all or part of the inner arm.

14. The foot rest of claim 1, wherein the outer pivotable mount comprises a stop mechanism that does not allow the outer arm to extend beyond an outer angle of 180°.

15. The foot rest of claim 1, wherein the inner arm is orientated at about 45° from a longitudinal axis of the motorcycle and the outer arm is oriented at about 90° from the longitudinal axis, when the foot rest is deployed.

16. The foot rest of claim 1, further comprising a latch mechanism configured to lock the inner arm stowed with a substantially 0° angle at the outer pivotable mount.

17. The foot rest of claim 16, wherein the latch mechanism comprises an externally actuatable release.

18. The foot rest of claim 1, further comprising a spring loaded mechanism urging the outer arm to pivot away from the inner arm.

19. The foot rest of claim 1, further comprising frictional surfaces or irregular surfaces on the inner arm or outer arm.

20. The foot rest of claim 1, comprising a metal or a composite.

21. The foot rest of claim 1, wherein a force of 200 pounds in a direction parallel to a longitudinal axis of the motorcycle on the outer arm of a mounted and deployed foot rest does not deflect the outer arm more than 5%.

22. A foot rest for mounting to a motorcycle frame, the foot rest comprising:
a mounting bracket attached to an inner arm comprising an outer section; and,
an outer arm pivotably mounted to the inner arm outer section, wherein the outer arm pivots on a pivot axis within 60 degrees of vertical when the foot rest is mounted to the frame.

23. The foot rest of claim 22, wherein the mounting bracket is mounted on the motorcycle frame to functionally receive a foot of a driver or passenger at the inner arm or the outer arm.

24. The foot rest of claim 22, wherein the mounting bracket is slidably mounted allowing vertical repositioning of the foot rest on the frame or allowing horizontal repositioning of the footrest.

25. The foot rest of claim 22, wherein the foot rest is configured to mount on the motorcycle with the inner arm directed forward of a transverse axis of the motorcycle, thus forward offsetting the outer arm.

26. The foot rest of claim 22, wherein the foot rest shares the mounting bracket with another foot rest or has an unshared mounting bracket.

27. The foot rest of claim 22, wherein the inner arm further comprises a longitudinal slot capable of receiving all or part of the outer arm or the outer arm comprises a longitudinal slot capable of receiving all or part of the inner arm.

28. The foot rest of claim 22, wherein the outer pivotable mount comprises a stop mechanism that does not allow an outer angle between the inner arm and outer arm to exceed 180°.

29. The foot rest of claim 22, wherein the outer arm pivots on a pivot axis within 45 degrees of vertical when the foot rest is mounted to the frame.

30. The foot rest of claim 22, wherein the outer arm pivots on a pivot axis that is substantially vertical when the foot rest is mounted to the frame.

31. The foot rest of claim 22, further comprising a latch mechanism configured to lock the inner arm and outer arm in contact with an angle of about 0° at the outer pivotable mount.

32. The foot rest of claim 31, wherein the latch mechanism comprises an externally actuatable release.

33. The foot rest of claim 22, further comprising a spring loaded mechanism urging the outer arm to pivot away from the inner arm.

34. The foot rest of claim 22, further comprising frictional surfaces or irregular surfaces on the inner arm or outer arm.

35. The foot rest of claim 22, wherein the inner arm attachment mount comprises a inner pivotable mount.

36. The foot rest of claim 35, wherein the inner pivotable mount comprises a position locking mechanism.

37. The foot rest of claim 36, wherein the inner arm can be locked in an orientation selected from the group consisting of: directed up, directed down and directed horizontally.

38. The foot rest of claim 35, wherein the inner pivotable mount comprises a pin-in-slot joint.

39. The foot rest of claim 35, wherein the inner pivotable mount pivots on a generally horizontal axis or pivots on an axis substantially perpendicular to a frame member on which it is mounted.

40. The foot rest of claim 35, wherein the outer arm pivots on an axis oriented substantially 90 degrees from a pivot axis of the inner arm.

41. The foot rests of claim 22, comprising a metal or a composite material.

42. The foot rests of claim 22, wherein a force of 200 pounds in a direction parallel to a longitudinal axis of the motorcycle on the outer arm of a mounted and deployed foot rest does not deflect the outer arm more than 5%.

43. A foot rest for mounting to a motorcycle frame, the foot rest comprising:
a mounting bracket attached to an inner arm comprising an outer section;
an outer arm pivotably mounted to the inner arm outer section; and,
a spring loaded mechanism urging the outer arm to pivot away from the inner arm.

44. The foot rest of claim 43, further comprising a latch mechanism configured to releasably retain the outer arm in a stowed position in contact with the inner arm.

45. The foot rest of claim 44, wherein the latch mechanism comprises an externally actuatable release.

46. The foot rest of claim 43, wherein the inner arm further comprises a longitudinal slot capable of receiving all or part of the outer arm or the outer arm comprises a slot capable of receiving all or part of the inner arm.

47. The foot rest of claim 43, wherein the outer arm pivots on a pivot axis that is substantially vertical when the foot rest is mounted to the frame.

48. The foot rest of claim 43, wherein the inner arm attachment of the mounting bracket to the inner arm comprises a pivotable mount.

49. The foot rest of claim 48, wherein the inner pivotable mount comprises a position locking mechanism.

50. The foot rest of claim 49, wherein the inner arm can be locked in an orientation selected from the group consisting of: directed up, directed down and directed horizontally.
